(19) United States
(12) Patent Application Publication
(10) Pub. No.: US 2008/0085095 A1
(43) Pub. Date: Apr. 10, 2008

(54) Self Recorded Video Greeting Card

(76) Inventor: Gerry Taccone, West Paterson, NJ (US)

Correspondence Address: Gerry Taccone, 48 Wynwood Road, Chatham, NJ, 07928, US

(21) Appl. No.: 11/469,868

(22) Filed: Oct. 6, 2006

(51) Int. Cl. H04N 9/00

(52) U.S. Cl. 386/39

(57) ABSTRACT

The card will include all equipment necessary to record the personal video message. The “Self Recorded Video Greeting Card” is a unique product that will contain many existing pieces of equipment. The pieces of equipment included within the “Self Recorded Video Greeting Card” are a viewing screen, camera lens, battery or other power source, memory chip, buttons for recording video/audio, microphone and a speaker. The final product purchased by the customer requires no additional software, hardware, batteries and etc.

### BRIEF SUMMARY OF THE INVENTION

The invention described in this document is for a new type of greeting card. The invention name is “Self Recorded Video Greeting Card”. As the name describes, this new greeting card will allow a customer to record a short video within the card.

The card will allow a customer to record/rerecord a personalized video with sound, to include in their greeting card, which the recipient can view. The number of views will only be limited by the power source life.

### BRIEF DESCRIPTION OF THE SEVERAL VIEWS OF THE DRAWING

FIG. 1—Front View

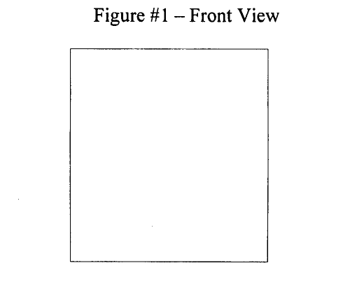

The front of the card will appear like any other greeting card. It will contain text and art work related to the cards theme. For example, Happy Birthday Grandma with balloons. There is nothing new or unique about the front of the card.

FIG. 2—Inside View

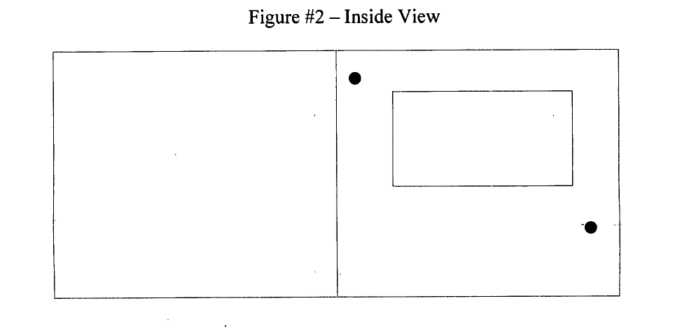

The inside of the card would include the video screen, the play button and a speaker. In addition the inside of the card will include more text and blank space for a customer to add writing.

FIG. 3—Back View

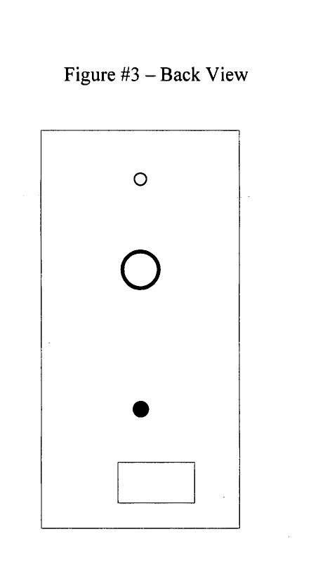

The back of the card would include the camera lens, record button and microphone. The back of the card will also include a bar code for scanning price and other product information.

### DETAILED DESCRIPTION OF THE INVENTION

The “Self Recorded Video Greeting Card” will be a greeting card that a customer purchases for various occasions. The “Self Recorded Video Greeting Card” will be roughly the same size as existing greeting cards but will allow the customer to create a personal video message. The video will be recorded using the equipment include within the card. The customer will not need to purchase any addition equipment or download any software. The “Self Recorded Video Greeting Card” will contain both video and audio as well as a power source. The customer will record their personal video/audio message plus any additional hand written text. The customer can then view their personal message and determine if they are satisfied. If not, they will be able to rerecord their video/audio message. Once the customer is satisfied with their personal message, the card can be given or mail to the intended recipient.

The recipient of the “Self Recorded Video Greeting Card” will open the card and the video and audio message will begin playing. The opening and closing of the card will start and stop the video. The recipient enjoy the video and audio message as long as the power source remains viable.

1. This invention is a unique product that does not exist in the market today. While both greeting cards and personal video recorders are commonly available to the consumer, there is no product that provides the service of the “Self Recorded Video Greeting Card”. The uniqueness of this product and its design make it an invention and warrant a patent.
